(19) United States
(12) Patent Application Publication
(10) Pub. No.: US 2011/0120029 A1
(43) Pub. Date: May 26, 2011

(54) Flexible material greenhouse or building "umbrella vent" system

(76) Inventor: William Michael Uschock, Greensburg, PA (US)

(21) Appl. No.: 12/592,320

(22) Filed: Nov. 23, 2009

(51) Int. Cl. F24F 7/02; E05F 11/00

(52) U.S. Cl. 52/199; 49/324

(57) ABSTRACT

A roof vent system for greenhouses or buildings comprised of a flexible sheet of material permanently attached stationary to a lower member of vent frame and towed by a flexible tube to open or close to upper peak member of said vent by winch assisted tether ropes and closed at building ends of said vent by free flexible material grommeted and tensioned by tether ropes attached to building end walls, producing a continuous flexible window. Flexible torsion hoops provide a support system for flexible sheeting materials and at the same time act as retracting mechanisms as the said vent is being opened. The vent system is longitudinal and transverses a building from end to end functioning to evacuate heat, humidity or other elements. Opening the vent requires releasing the winch locked tethers so that the flexible material which is attached to a pull pipe is free to descend down the slope of the building roof. Tethers are used to pull the vent to a close at the peak while reverse tethers or a pole prop can be used to assist opening.

### BACKGROUND

### Prior Art

This invention is an affordable method to vent greenhouses or other building roofs, using common relatively low cost available inputs. The flexible “umbrella vent” is durable in wind and rain whether closed or fully open. In the closed position, the vent is locked down by tensioned tether ropes secure from wind and rain. In the vertical fully open position, the “umbrella vent” system flexes in the wind supported by flexible tension hoops. When in the open position, the plastic folds approximately in half. This utility design is different from prior roof vent systems that primarily use costly rigid windows and rack and pinion mechanisms and are vulnerable to wind in the open positions as well as multiple sealing issues.

The “umbrella vent” technology is based upon principles of tension and support to create a functional method to employ the use of lower cost flexible plastic sheeting in a controlled system to vent greenhouse or other building's air. The flexible “umbrella vent” system eliminates multiple fragmented openings of prior venting applications by the continuous uninterrupted use of a single sheet of flexible plastic or materials that are moveable and controlled while opening to vent air.

### DETAILED DESCRIPTION

### Preferred Embodiment

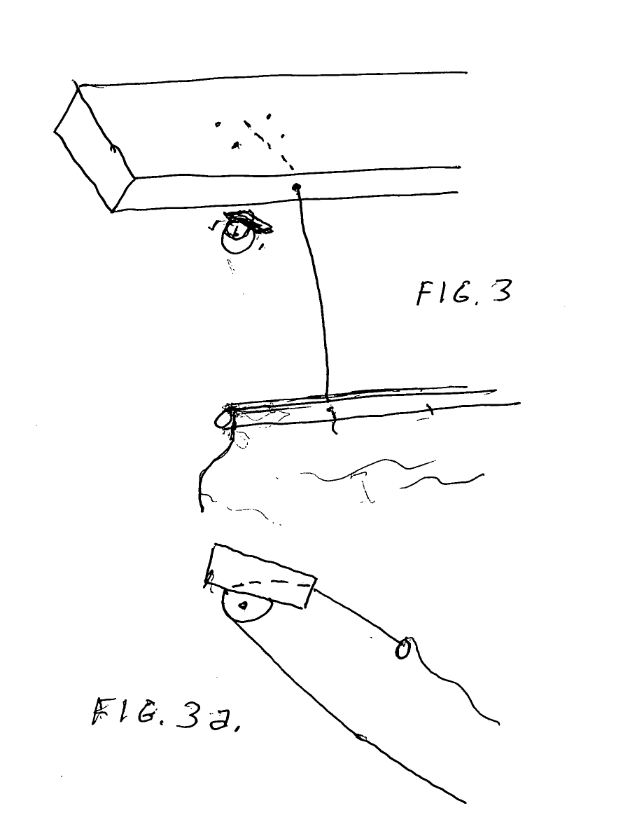

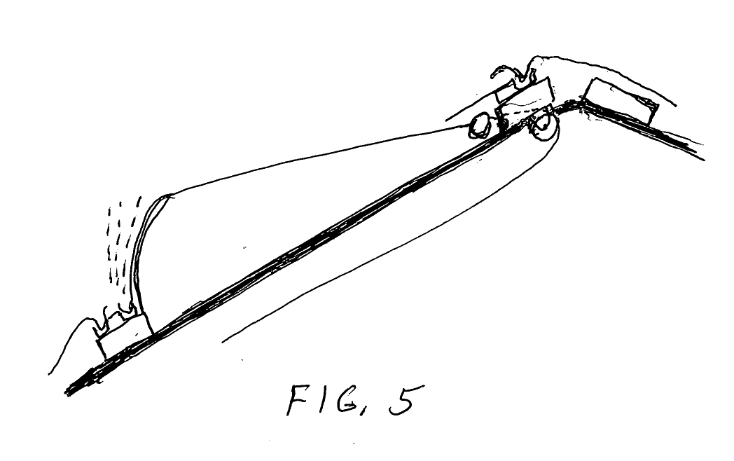

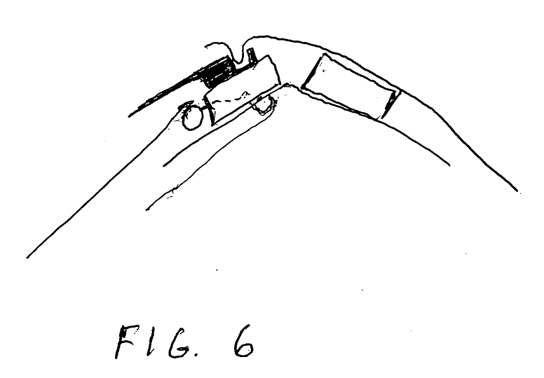

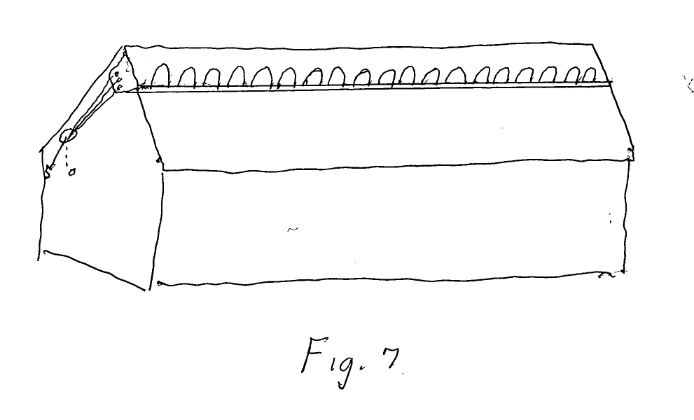

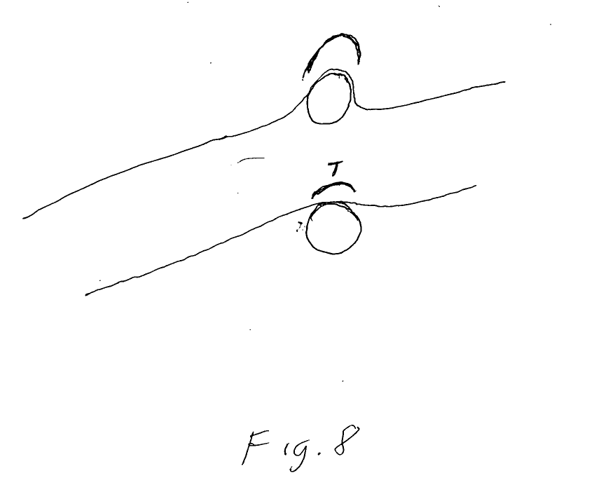

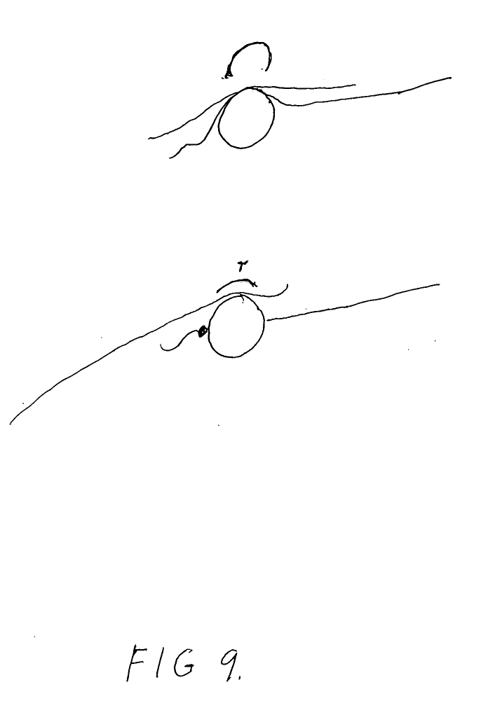

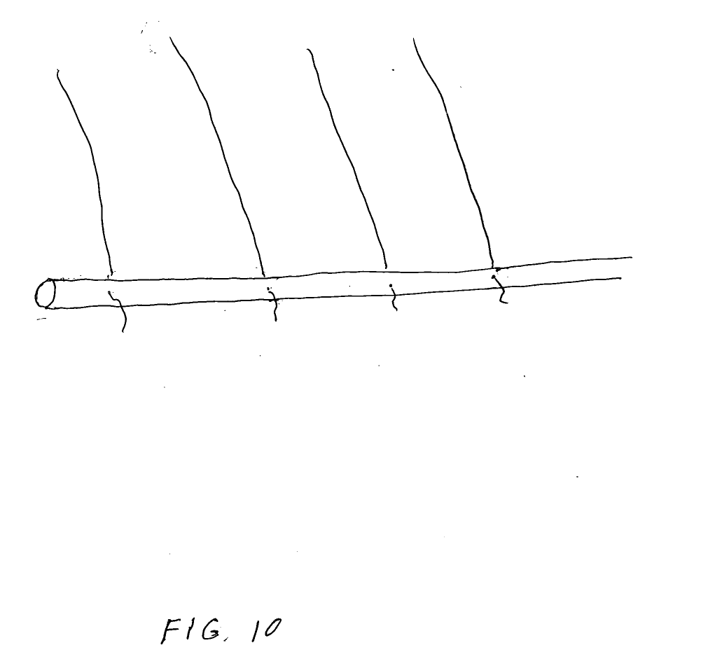

This invention design provides up to a four foot opening for ventilation of a greenhouse roof vent that is covered with flexible plastic sheeting. The retractable umbrella greenhouse vent is mounted between two horizontal 2″×4″ treated wood members which can also be steel or aluminum (FIG. 2). The horizontal members are clamped or screwed onto a greenhouse or building frame, the highest member 2″×4″ being at or near the peak and the lower member 2″×4″ placed 4 feet lower down the slope of the greenhouse roof. Wire hoops acting as support and torsion are inserted into the lower horizontal member of the vent frame by drilling a small hole to receive the 76″× 3/16″ wire torsion hoops (FIG. 4). The hoop holes are above the poly-lock extrusion mounted on the same lower vent member. The hoops are placed one after another, spanning one greenhouse or building rafter or bow to the next to form a wall of torsion hoops that run the length of a greenhouse or building (FIG. 7). Flexible woven or conventional plastic sheeting or another flexible material is attached to the lower member of the vent just behind the wall of hoops (FIG. 5). The flexible plastic sheeting is pulled up and over the wall of hoops which tensions the plastic (FIG. 5), advancing to a pull pipe and is attached to the pull pipe with screwed on compression clamps (FIG. 8). The pull pipe tows the plastic toward the peak via tether ropes. The ⅛″ or 3/16″ polyester braided ropes are connected to the pull pipe by passing through drilled holes and, are knotted or by clamping onto the pull pipe (FIG. 9). The pull pipe is standard galvanized 1.315 greenhouse rollup curtain pipe or other pipe or tube. The hoop torsion system is different from any other plastic system because it simultaneously retracts and tensions free plastic or flexible sheeting in a venting process (FIG. 5). The plastic or flexible sheeting for the vent requires an additional width of about 1 foot more or less to allow the tensioning function to work properly. For example, approximately 5 feet of flexible material is needed for a 4 foot opening. This slack provides free play so that when the tethered pull pipe is winched to close the vent, the torsion hoops are slightly flexed from the near vertical position toward the inclining slope of the greenhouse or other building rafters or bows (FIG. 5). This creates the umbrella effect which will shed rain and protect against wind forces. When the vent is closed the plastic or flexible material is fully tensioned. As the tethers are released from the lock down winch to open the vent, the torsion hoops retract to near vertical again retracting the pull pipe and flexible material to an opening of a foot or more. In a 96 foot greenhouse or other building, 12 rope tethers spaced 8 feet apart provide uniform pulling closing functions. The rope tethers are passed through the pipe and knotted or clamped so that the pipe and flexible material in tow can be pulled to the peak board (FIG. 6). The tether ropes continue to 9/32″ drilled holes in the peak board edge. The peak board holes are drilled through the peak board edge mid point at an angle toward vertical mounted pulleys which are screwed to the underside upper elevation of the peak board. This allows the pull pipe to close to the peak board edge unobstructed, taking care to align tether rope with pulley.

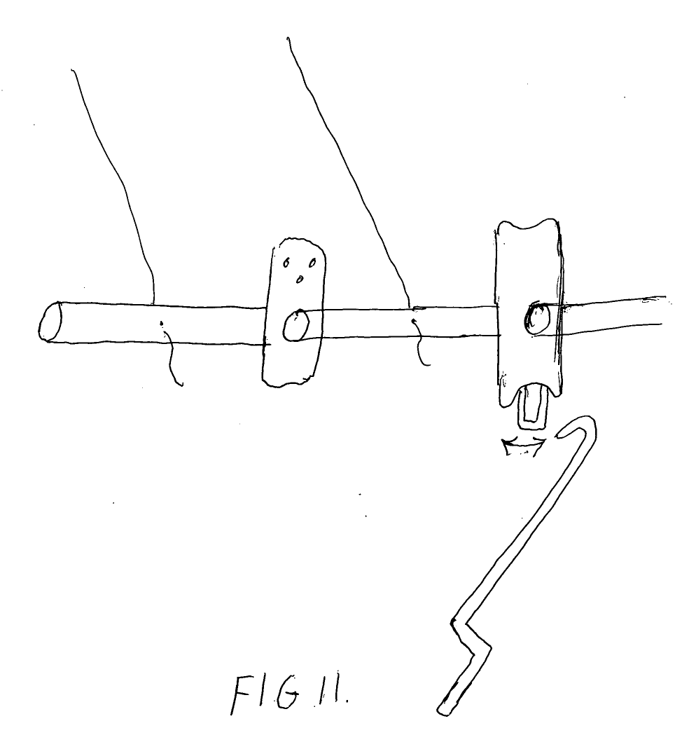

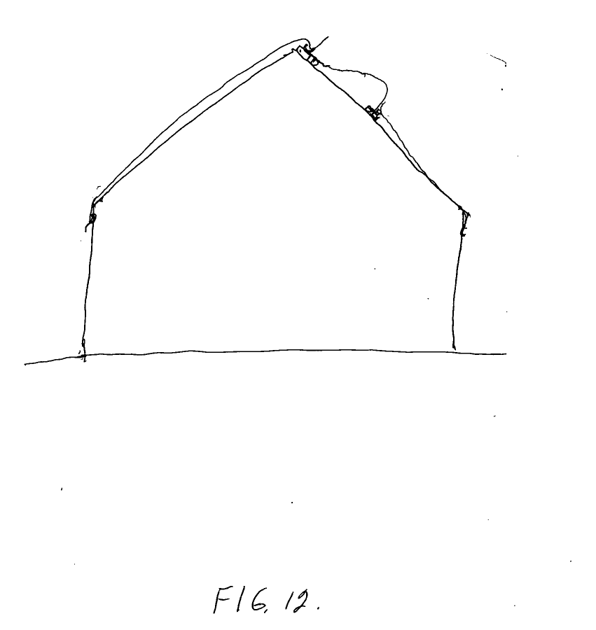

The tether ropes continue from the pull pipe passing through the peak board to the vertical mount pulleys which are mounted to the underside of the 2″×4″ peak board member, traversing through the pulley and advancing to mounted crank winches at lower greenhouse or building frame. The tether ropes turn 180 degrees at the vertical pulley (FIG. 5) proceeding back under the vent to a horizontal crank winch device (FIG. 10). The crank pipe is horizontal and transverses the length of the greenhouse or building. The tether ropes being connected to the pipe and powered by a dual output stationary winch gear box (FIG. 11) to provide necessary torque to open or close the “umbrella vent”. When the gear box is turned by a cordless drill or a hand crank, tether ropes are pulled simultaneously (FIG. 11). The dual-output gear box mounts in the center of the greenhouse or building separating the crank pipe in two directions.

An additional compliment to the umbrella greenhouse or building vent system is the installation of an aluminum extrusion at the peak that combines a poly lock for the permanent stationary plastic or flexible material attachment of the opposing fixed roof while at the same time extending plating to function as a drip cap for the flexible vent (FIG. 6). This dual purpose aluminum extrusion includes a 3″ extension for the drip cap and a lockdown for the opposing permanent roof plastic or flexible material. The drip cap seals the peak board weather juncture from rain and ice. Closure at the gable ends of the greenhouse or building “umbrella vent” is accomplished by extending free plastic 4 foot and inserting 3 grommets which provide attachment points for 3 rope tethers joined to a steel ring attached to a light bungee cord to anchor at the end wall of the greenhouse or building to a steel eyebolt (FIG. 7). Flexing of the bungee allows the partial opening of the “umbrella vent”. To open the “umbrella vent” fully, the bungee is moved to a second eyebolt to relax the end wall tethers further (FIG. 7)

### DRAWINGS

### Figures

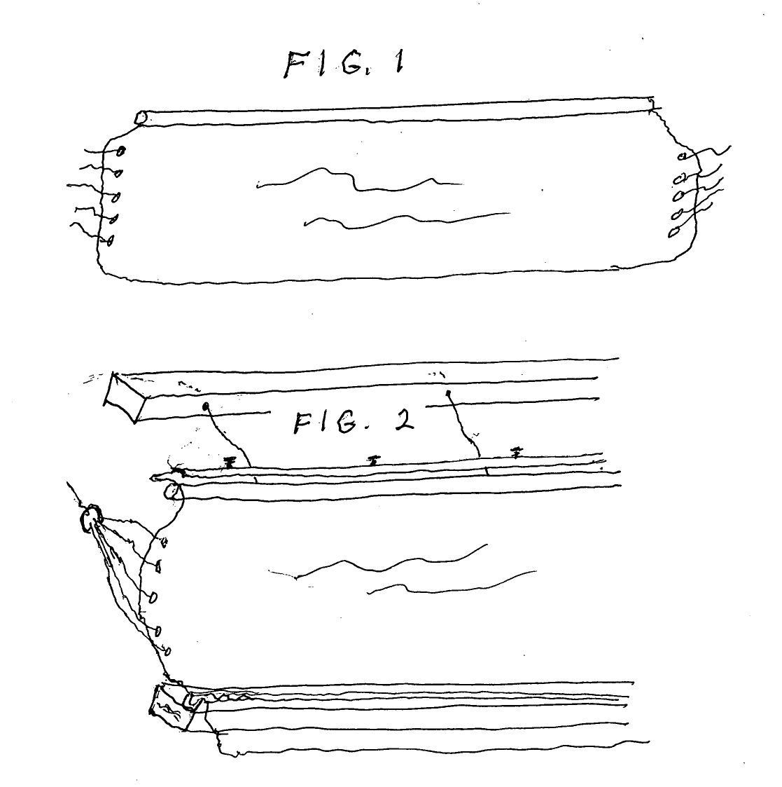

FIG. 1 shows a longitudinal piece of continuous flexible plastic sheeting or of other flexible poly-like materials. Extended flexible material projects beyond the roof ends turning to vertical sides at gable or bow ends. Grommets are attached and tether ropes are secured proceeding to a ring attached to a single bungee cord which anchors to an eye bolt lower down the end wall which functions to close the roof vent at the building ends.

FIG. 2 demonstrates flexible material attachment to galvanized pipe which serves in pulling or retracting the said material. The tether ropes are very low stretch polyester.

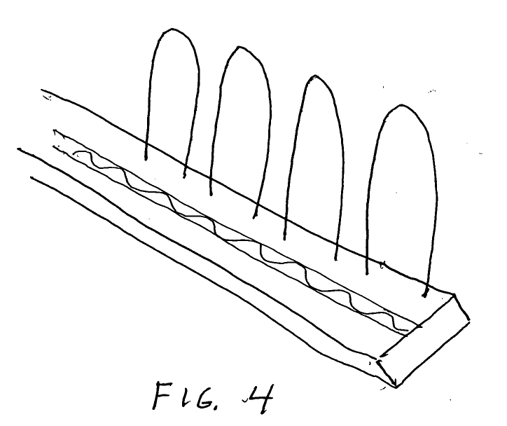

FIG. 3 exhibits the peak board member with a vertical mount pulley screwed to the underside of the board. FIG. 3a shows a drilled hole which tapers to the vertical pulley at a slight elevation under the peak board. Tether ropes of the vent system pass through the holes in the peak board edge to enjoin the pulleys.

FIG. 4 shows the torsion hoops that tension the flexible material.

FIG. 5 demonstrates the tension effect and convexity of the umbrella like vent, as the vent is cranked or pulled to close.

FIG. 6 demonstrates the unique drip cap sealing fixture which at the same time provides a clamp for flexible material from opposing roof.

FIG. 7 shows building vent with hoops installed.

FIG. 8 shows a compression clamp and a screwed on clamp.

FIG. 9 shows pull rope under compression clamp or alternate pull rope passing through pull pipe.

FIG. 10 shows horizontal pipe for crank with tethers.

FIG. 11 shows gear box and horizontal pipe with crank.

FIG. 12 shows building end view of flexible material in a convex profile as the vent is closed.

I claim:

1. A controlling manipulation of winched tethers and flexible pipe attached to continuous flexible sheet material upon an inclined plane with the flexible sheet material pulled over top of multiple hoops that act as support and tension to avoid collapse from wind or rain creates a ventilation window in an umbrella like function, which also employs a necessary drip cap combination polylock extrusion at the peak of roof closure.

2. The ventilation window of claim 1 is comprised of flexible sheet material, tether rope, pulley, winch, pipe, hoops, drip cap extrusion, polylock, and grommet.

3. The ventilation window of claim 1 is controlled through the use of pipe, flexible material, tether rope, pulley, winch and hoop torsion, whereby tensioning flexible plastic or other flexible material to accomplish said vent by towing said material via a pull pipe upon an inclined plane of roof advancing to a peak board and through the peak board to a vertical mount pulley on the underside of the said peak board.

4. When flexible sheet material is pulled over top of hoops by pull pipe and tether rope as described in claim 1, a bending action of the hoops is created which tensions the flexible sheet material.

5. Hoops to support flexible sheet material as described in claim 1 are installed in a continuous fashion forming a wall of hoops allowing the said hoops and flexible sheet material the ability to flex in the wind.

6. A combination drip cap polylock extrusion has the ability to simultaneously lock down the flexible sheet material of the opposing non vented side of the roof and afford protection from wind, rain, snow, and ice for the leading edge of the said flexible sheet material vent by extending over the said vented side.

7. Additional rope tethers attached to the pull pipe assist to fully retract the flexible vent of claim 1 after the tension is relieved from hoops as they return to a preset near vertical position. Alternately, a pole prop can be used to fully push open the flexible vent down the roof slope.

8. Flexible sheet material as described in claim 1 is extended beyond the roof at building end walls and is grommeted and tethered with multiple tethers to a secured bungee cord attaching to a fixed eye bolt forming a sealed closure at building ends, while releasing said bungee to open the said vent.

9. An apparatus winching system to open or close a flexible sheet material vent as described in claim 1 includes a crank pipe of 1.315 standard greenhouse roll pipe mounted in hangers the length of the building with a crank winch gear box mounted at the mid point of the horizontal run of the pipe and suspended from the rafters or bows near the sidewall of the said building allowing for accessible reach with a metal hand crank or powered by a cordless drill to open or close said vent.

10. Hoops as described in claim 1 can be 3/16″ high tensile steel or spring steel wire, the height of hoops adjusted relative to the pitch of roof, higher hoops for steeper roofs and lower hoops for less rise, providing necessary slope to evacuate water or rainfall when the “umbrella vent” is pulled to a fully closed position. Hoops can also be positioned at selected degrees from vertical toward the vent peak to adjust for pitch or to lessen tensioning effect. Spacing hoops and reducing size and height of hoops may be employed for flat peak profile quonset roofs, adjusting for slope and to provide valleys between hoops to evacuate water, comparable to personal umbrella function.
